(19) United States
(12) Patent Application Publication
(10) Pub. No.: US 2007/0115464 A1
(43) Pub. Date: May 24, 2007

(54) System and method for inspection of films

(76) Inventors: Kevin George Harding, Niskayuna, NY (US); Robert William Tait, Brighton, MI (US); Mark Allen Cheverton, Mechanicville, NY (US)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 11/285,332

(22) Filed: Nov. 21, 2005

(51) Int. Cl. G01N 21/88

(52) U.S. Cl. 356/239.2

(57) ABSTRACT

Disclosed herein is a method for inspection of light management films with a plurality of light refractive surface structures, including positioning at least one illumination source, and at least one imaging device are configured to be in a substantially bright field configuration and imaging at least portion of the light management film to provide an acquired image, wherein light from the at least one illumination source is refracted by the film to produce a dark field image at the at least one imaging device. A system for inspection of light management films is also provided. The system includes at least one illumination source to illuminate a first side of the film, at least one imaging device to receive light refracted through an opposite side of the light management film, wherein the illumination source and the imaging device are configured to be in a substantially bright field configuration to acquire a dark field image, a processor-controller, and a computer-readable medium including instructions for automated defect detection. The fixture, the illumination source, the imaging device, the processor-controller and the computer readable medium are operably coupled for automated defect detection.

### BACKGROUND

The invention relates generally to inspection techniques for films. In particular, the invention relates to inspection techniques for films with refractive structures.

Detection of defects in films without detecting their natural texture is always a challenge. Light management films used in LCD displays are typically films with refractive structures, such as prismatic structures, on one side of the film. Typically, such films with refractive structures serve a light-collimation function by refracting the light preferentially toward the normal of the display and thus towards the viewer. This effect also tends to reduce the viewing angle of the LCD display, causing the display to appear brighter.

Defects on these films can be in the form of refractive structure surface damages, inclusions, and scratches as well as similar defects on the base film. All such defects cause light to scatter and bend at different angles, making them visible to the customer and making the film unacceptable. As refractive structures bend light, the structure could itself be mistakenly detected as a defect during inspection. But deformities in the refractive structure, as well as inclusions, are defects that must be detected.

Defects in light management films are typically caused during production and handling. It is very desirable to assess the quality of the films, to determine the numbers and types of defects on the films, so that the production and handling processes can be corrected to improve product quality.

Accordingly, a technique is needed to address one or more of the foregoing problems in the inspection of films with surface refractive structures.

### BRIEF DESCRIPTION

One aspect of the present invention includes a method for inspection of light management films. The method includes providing a light management film including a plurality of light refractive surface structures, mounting said light management film onto a fixture, positioning at least one illumination source to illuminate a first side of the light management film, and positioning at least one imaging device on a side opposite said first side, wherein the at least one illumination source, and the at least one imaging device are configured to be in a substantially bright field configuration and imaging at least portion of the light management film to provide an acquired image, wherein light from the at least one illumination source is refracted by the film to produce a dark field image at the at least one imaging device.

One aspect of the present invention includes a method for automated inspection of films. The method includes providing a film including a plurality light refractive surface structures on a first side of said film, mounting said film onto a fixture, positioning at least one illumination source to illuminate the film, and positioning at least one imaging device to receive light emerging from the film, wherein the at least one illumination source, and the at least one imaging device are configured to be in a substantially bright field configuration, imaging at least portion of the film to provide an acquired image, wherein light from the at least one illumination source is refracted by the film to produce a dark field image at the at least one imaging device, and processing the acquired image using a processor-controller, wherein the illumination source, the imaging device, the film, and the processor-controller are operably coupled for automated defect detection.

Another aspect of the present invention includes a computer readable medium including instructions for automated inspection of light management films. The computer-readable medium includes computer instructions for instructing a processor-controller for generating a scanplan for inspection of a light management film, the computer instructions including loading a geometric model of the light management film and the fixture and generating a scanplan of the light management film based on the geometric model and at least one scanning parameter.

A further aspect of the present invention includes a system for automated inspection of light management films. The system includes a fixture for mounting a film including a plurality of light refractive surface structures, at least one illumination source to illuminate a first side of the film, at least one imaging device to receive light refracted through an opposite side of the light management film, wherein the illumination source and the imaging device are configured to be in a substantially bright field configuration to acquire a dark field image, a processor-controller, and a computer-readable medium. The fixture, the illumination source, the imaging device, the processor-controller and the computer readable medium are operably coupled for automated defect detection. The computer readable medium includes instructions for automated defect detection.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic representation of a film with light refractive surface structures;

FIG. 2 is a schematic representation of imaging a film with light refractive surface structures in accordance with one embodiment of the present invention;

FIG. 3 is a schematic representation of imaging a film with light refractive surface structures in accordance with one embodiment of the present invention;

FIG. 4 is a schematic representation of imaging a film with light refractive surface structures in accordance with one embodiment of the present invention;

FIG. 5 is a schematic representation of imaging a film with light refractive surface structures in accordance with one embodiment of the present invention;

FIG. 6 is a schematic representation of imaging a film with light refractive surface structures in accordance with one embodiment of the present invention;

FIG. 7 is a schematic representation of imaging a film with light refractive surface structures in accordance with one embodiment of the present invention;

FIG. 8 is a schematic representation of imaging a film with light refractive surface structures in accordance with one embodiment of the present invention;

FIG. 9 is a schematic representation of imaging a film with light refractive surface structures in accordance with one embodiment of the present invention;

FIGS. 10, 11, 12 and 13 are cross sectional views of films with light refractive surface structures;

FIG. 14 is a schematic representation of a system for automated inspection of light management films in accordance with one embodiment of the present invention;

FIG. 15 is a flow chart illustrating a method for automated inspection of light management films in accordance with one embodiment of the present invention;

FIG. 16 is a flow chart illustrating a method for automated inspection of light management films in accordance with one embodiment of the present invention;

FIG. 17 is a flow chart illustrating a method for automated inspection of light management films in accordance with one embodiment of the present invention;

FIG. 18 is a flow chart illustrating a method for automated inspection of light management films in accordance with one embodiment of the present invention;

FIG. 19 is a flow chart illustrating a method for automated inspection of light management films in accordance with one embodiment of the present invention;

FIG. 20 is a flow chart illustrating a method for automated inspection of light management films in one embodiment of the present invention;

FIG. 21 is a micrograph of a light management film in accordance with one embodiment of the present invention;

FIG. 22 is a micrograph of a light management film in accordance with one embodiment of the present invention;

FIG. 23 is a micrograph of a light management film in accordance with one embodiment of the present invention;

FIG. 24 is a micrograph of a light management film in accordance with one embodiment of the present invention;

FIG. 25 is a micrograph of a light management film in accordance with one embodiment of the present invention;

FIG. 26 is a micrograph of a light management film in accordance with one embodiment of the present invention; and

FIG. 27 is a micrograph of a light management film in accordance with one embodiment of the present invention.

### DETAILED DESCRIPTION

Embodiments of the present invention disclose systems and methods for inspection of films with light refractive surface structures.

Illumination source-imaging device configurations are conventionally categorized into two different configurations. In a bright field configuration, an imaging device looks directly into an illumination source, with a part being inspected positioned in between the illumination source and the imaging device, producing a bright field image. In this configuration, light from the illumination source passes through the part under inspection, and the imaging device detects most of the transmitted light. However, defects and inclusions in the part being inspected, block and scatter light away from the imaging device, and are seen by the imaging device as dark spots. As a result, in the image the defects typically look dark with the background being bright, such an image is referred to as a bright field image. The second type of configuration is called a dark field configuration, which produces a dark field image. In a dark field configuration, the imaging device is positioned off-axis from the illumination source. In a dark field configuration, light from the illumination source passes through the part under inspection, and most of the transmitted light misses the imaging device completely. However, a defect in the part may scatter or refract the light incident upon it such that it may desirably be directed towards the imaging device. An image obtained in this manner has a dark background with bright spots indicating defects, such an image being referred to as a dark field image.

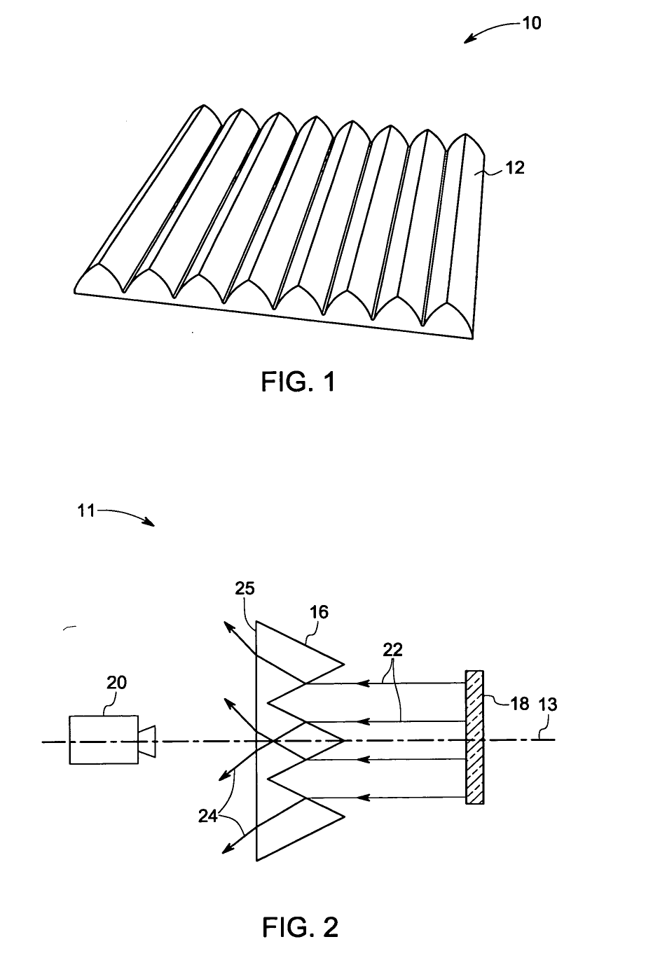

Embodiments of the present invention include methods and systems for inspection of films with light refractive surface structures, including light management films such as shown in FIG. 1, using a substantially bright field configuration to obtain a dark field image for detection of defects. As used herein and throughout the specification, the term “substantially bright field configuration” refers to a configuration wherein an imaging device looking into an illumination source, will in the absence of a film to be inspected, record a bright field image. As seen in FIG. 1, a light management film 10 has refractive structures 12, such as prismatic structures, on at least one side of the film. In some embodiments, the prismatic structures have prism angles of about 90 degrees. In other embodiments, the prism angle is less than 90 degrees. In still another embodiment, the prism angle is greater than 90 degrees.

The required spatial arrangement of the illumination source and the imaging device in a substantially bright field configuration to provide a dark field image of a light management film, may be dependent on several parameters including but not limited to degree of collimation or diffusivity of the light emerging from the illumination source, prism angle of the prismatic structures on the light management film, index of refraction of the material of the light management film, and degree of diffusiveness caused by the surface texture, such as polished, matte texture, and integrated diffuser structure, of the light management film on the side opposite to the side with the refractive structures. In some embodiments of the present invention, Given a certain illumination source, and a light management film, one or more parameters such as but not limited to the distance between the illumination source and the light management film, the distance between the light management film and the imaging device, the angle between the illumination source axis and the imaging device, and the angle between the light management and a perpendicular drawn to the plane of the light management film may be so chosen as to produce a dark field image in a substantially bright field configuration.

FIG. 2 is a schematic representation of imaging a film with light refractive surface structures without defects, in accordance with one embodiment of the present invention. In this embodiment, a system 11 is used to image a film 16 with refractive structures such as a light management film with prismatic structures. The system 11 includes an illumination source 18, which is placed on one side of the film 16, and an imaging device 20, which is placed on the other side of the light management film 16. Non-limiting examples of light sources include fluorescent sources, incandescent sources, halide sources, halogen sources, organic and inorganic light emitting diodes (LEDs), diode lasers, and fiber optic sources. Non-limiting examples of imaging devices include line scan cameras and area scan cameras. The illumination source 18, and the imaging device 20 are in a substantially bright field configuration. As used herein, the term “imaging device angle”, refers to an angle subtended by the imaging device with respect to an illumination source axis drawn perpendicular to the plane of the illumination source. In one embodiment, the imaging device angle θ₁ is selected to be in a range from about plus or minus 30 degrees. In a further embodiment, the imaging device angle θ₁ is selected to be in a range from about plus or minus 15 degrees. In some embodiments, the imaging device angle θ₁ is selected to be in a range from about plus or minus 5 degrees. In certain embodiments, the imaging angle θ₁ is zero degrees as shown in FIG. 2. The light rays 22 emanating from the illumination source are incident on the film 16.

In some embodiments, the illumination source is a diffuse source. Non-limiting examples of diffuse light sources include but are not limited to cold cathode fluorescent tube back light modules for notebook and desktop computers, and for televisions and displays, LEDs for notebook and desktop computers, and for televisions and displays. In other embodiments, the illumination source is a collimated source. In some embodiments, the illumination source is a point illumination source, whereas in some other embodiments the illumination source is an area illumination source. In still other embodiments, the light source is a line light source. To generate a required degree of collimation or diffusivity of the light incident on the light management film, additional optical elements may be used. In some embodiments, illumination sources may include light management components such as reflectors, diffusers, polarizers, collimating elements, and focusing elements.

In some embodiments, the film is disposed in a manner such that the refractive structures face the illumination source. In other embodiments, the film is disposed in a manner such that the refractive structures are towards the imaging device. The collimated light rays 22 from the illumination source 18, as shown in FIG. 2, are incident substantially perpendicular to the plane 25 of the light management film 16. As used herein, the term “substantially perpendicular” refers to an angle within plus or minus ten degrees of a normal drawn to the plane 25 of the film 16. The prismatic structures deflect the incident light away from the normal. The rays 24 emerge from the film refracted away from the imaging device 20. The imaging device 20 therefore sees and images a dark field image.

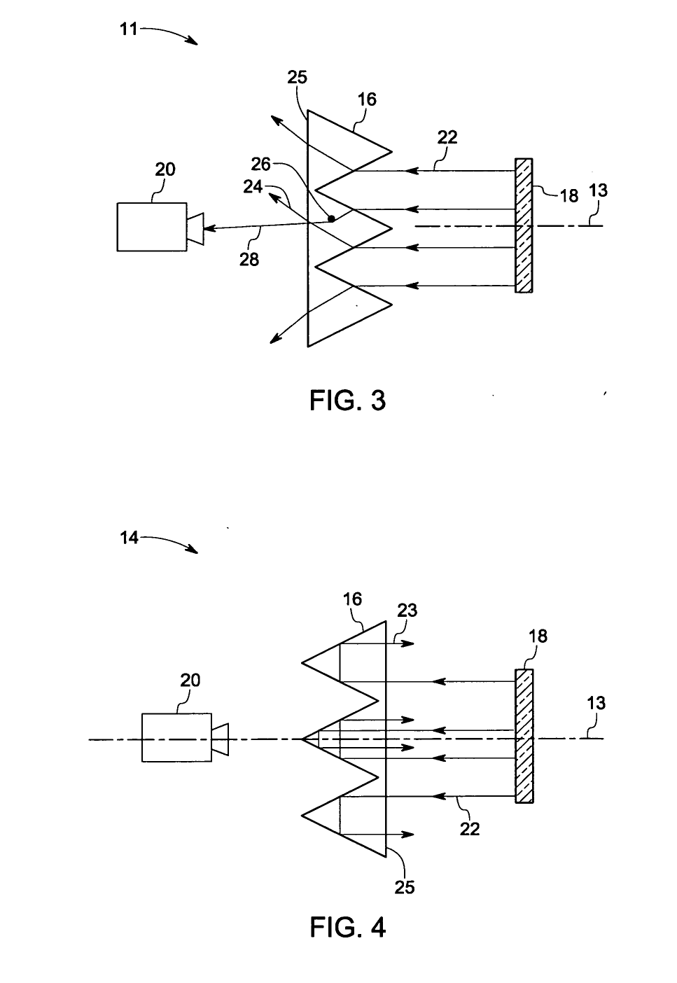

FIG. 3 is a schematic representation of imaging a film with refractive surface structures with defects, in accordance with one embodiment of the present invention. In this embodiment, a system 11 is used to image a film 16 with prismatic structures. The system 11 includes an illumination source 18, placed on one side of the film 16, and an imaging device 20, placed on the other side of film 16. The illumination source 18, and the imaging device 20 are in a substantially bright field configuration. The collimated light rays 22 emanating from the illumination source 18 are incident substantially perpendicular to the plane 25 of the film 16. In some embodiments, the film 16 is disposed in a manner such that the prismatic structures face the illumination source. The prismatic structures deflect the incident light away from the normal. Most rays 24 emerge from the film refracted away from the imaging device 20. But light falling on a defect feature 26 is scattered and deflected. The scattered light 28 emerges from the light management film 16 and is captured by the imaging device 20. The imaging device 20 therefore sees a bright spot corresponding to the defect feature in a dark background and images a dark field image. Therefore, a substantially bright field configuration produces a dark field image.

In the illustrated embodiment as shown in FIG. 4, a system 14 is used to image a film 16 with refractive structures such as a light management film with prismatic structures. The system 14 includes an illumination source 18 emitting collimated light, and is placed on one side of the film 16, and an imaging device 20 is placed on the other side of the light management film 16. The illumination source 18, and the imaging device 20 are in a substantially bright field configuration. The collimated light rays 22 emanating from the illumination source are incident on the film 16. In the illustrated embodiment shown in FIG. 4, the film is disposed in a manner such that the prismatic structures are towards the imaging device. The collimated light rays 22 from the illumination source 18 are incident substantially perpendicular to the plane 25 of the light management film 16. The prismatic structures retro reflect the light back towards the illumination source 18. The rays 23 emerge from the film retro-reflected back towards the illumination source 18. The imaging device 20 therefore sees and images a dark field image. In the presence of defects, light may be scattered by the defects and may be imaged by the imaging device.

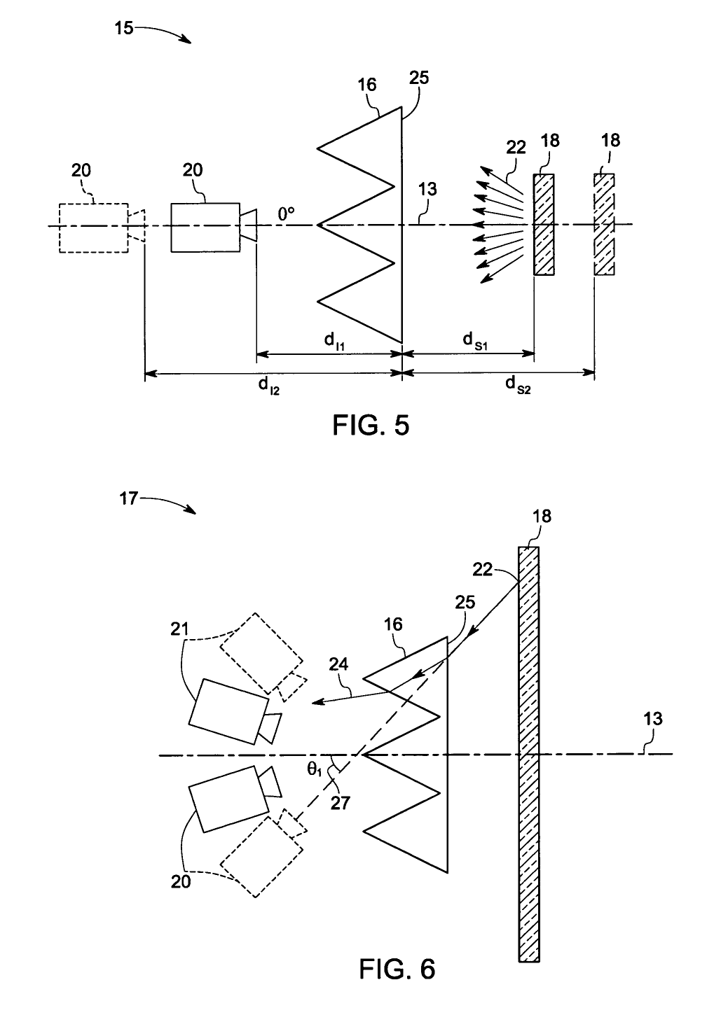

In the illustrated embodiment as shown in FIG. 5, a system 15 is used to image a film 16 with refractive structures such as a light management film with prismatic structures. The system 15 includes an illumination source 18 emitting diffuse light, and is placed on one side of the film 16, and an imaging devices 20 is placed on the other side of the light management film 16. The illumination source 18, and the imaging device 20 are in a substantially bright field configuration. In one embodiment, the imaging device angle θ₁ 27 is selected to be about zero degrees. The diffuse light rays 22 emanating from the illumination source is incident on the film 16. In the illustrated embodiment shown in FIG. 5, the film is disposed in a manner such that the prismatic structures are towards the imaging device. The diffuse light rays 22 from the illumination source 18 are incident at varied angles with respect to the plane 25 of the light management film 16. The prismatic structures may partially retro reflect the light back towards the illumination source 18. The prismatic structures may also partially refract the light. In some embodiments, the distance between the illumination source and the light management film, and the distance between the light management film, may be chosen so as to produce a dark field image in a substantially bright field configuration. In the illustrated embodiment shown in FIG. 6, at an illumination source to light management film distance dₛ₁, the configuration may produce a bright field image, whereas at a distance of dₛ₂, the configuration may produce a dark field image. Similarly an imaging device to light management film distance d₁ may be so chosen as to image a dark field image. The imaging device 20 therefore sees and images a dark field image. In the presence of defects, light may be scattered by the defects and may be imaged by the imaging device.

In the illustrated embodiment as shown in FIG. 6, a system 17 is used to image a film 16 with refractive structures such as a light management film with prismatic structures. The system 17 includes an illumination source 18 emitting diffuse light, and is placed on one side of the film 16, and at least one imaging device 20 is placed on the other side of the light management film 16. In some embodiments, a second imaging device 21 may also be used to image the light management film. The illumination source 18, and the imaging devices 20 are in a substantially bright field configuration. In one embodiment, the imaging device angle θ₁ 27 is selected to be in a range from about 10 degrees to 80 degrees. In another embodiment, the imaging device angle θ₁ 27 is selected to be in a range from about 30 degrees to 60 degrees. In some embodiments the imaging device angle is about 45 degrees. In one embodiment, the imaging device angle, which will provide a dark field image, may be determined by taking into account the angle at which light is incident on the light management film, prism angle of the refractive structures and the refractive index of the light management film. In another embodiment, the imaging angle θ₁ is determined by moving the imaging device until a bright field image is obtained. Diffuse light rays emanating from the illumination source 18 are incident at varied angles with respect to the plane 25 of the light management film 16. In the illustrated embodiment shown in FIG. 6, the film 16 is disposed in a manner such that the prismatic structures are towards the imaging device. With respect to a representative diffuse ray 22, as shown in FIG. 6, the imaging device is directly into looking into the illumination source, thereby providing a substantially bright configuration. Depending on the incident angle, the prismatic structures may partially retro reflect the light back towards the illumination source 18. The prismatic structures may also partially refract the light. The refracted ray 24 corresponding to the incident ray 22 emerges from the film 16 at such an angle that it is not imaged by the imaging device 20. The imaging device is positioned in such a manner that the refracted rays emerging from the film 16 are not imaged by the imaging device 20. The imaging device 20 therefore sees and images a dark field image. In the presence of defects, light may be scattered by the defects and may be imaged by the imaging device.

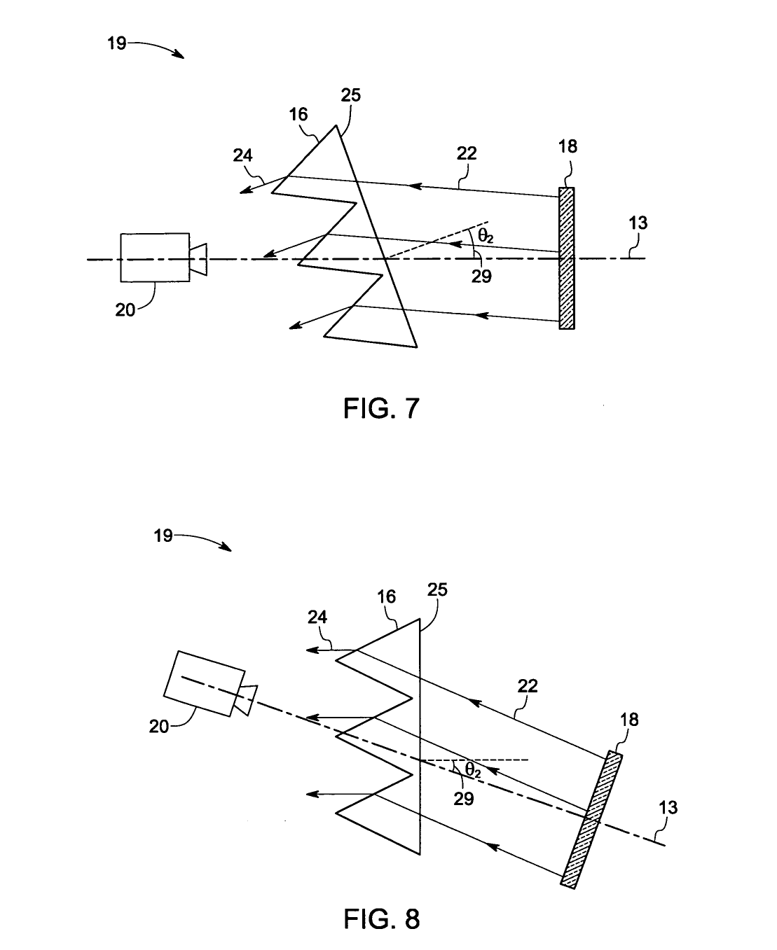

In the illustrated embodiment as shown in FIGS. 7 and 8, a system 19 is used to image a film 16 with refractive structures such as a light management film with prismatic structures. The system 19 includes an illumination source 18 emitting collimated light, and is placed on one side of the film 16, and an imaging device 20 placed on the other side of the light management film 16. The illumination source 18, and the imaging device 20 are in a substantially bright field configuration, but the plane of the light management film is at an angle θ₂ with respect to illumination source axis 13. The collimated light rays 22 emanating from the illumination source are incident on the film 16. In some embodiments, the illumination source may be positioned to configure the perpendicular drawn to the plane 25 of the light management film 16 to be at an angle θ₂ with respect to the illumination source axis 13, as shown in FIG. 7. In other embodiments, the film may be rotated about the illumination source axis 13 to position the film at an angle θ₂ as shown in FIG. 8. In some embodiments, the imaging device may also be repositioned along with the illumination source. In one embodiment, this angle θ₂ is selected to be in a range from 0 degrees to about 30 degrees. In another embodiment, this angle is selected to be in a range from about 15 to about 30 degrees. In the illustrated embodiments shown in FIGS. 6 and 7, the film is disposed in a manner such that the prismatic structures are towards the imaging device. The collimated light rays 22 from the illumination source 18 are incident at angles off-perpendicular with respect to the plane 25 of the light management film 16. In some embodiments, the collimated rays are incident perpendicular to at least one face of the prismatic structures. The rays 24 emerge from the film refracted at angles substantially perpendicular to the plane 25 of the film 16 and are not imaged by the imaging device. The imaging device 20 therefore sees and images a dark field image. In the presence of defects, light may be scattered by the defects and may be imaged by the imaging device.

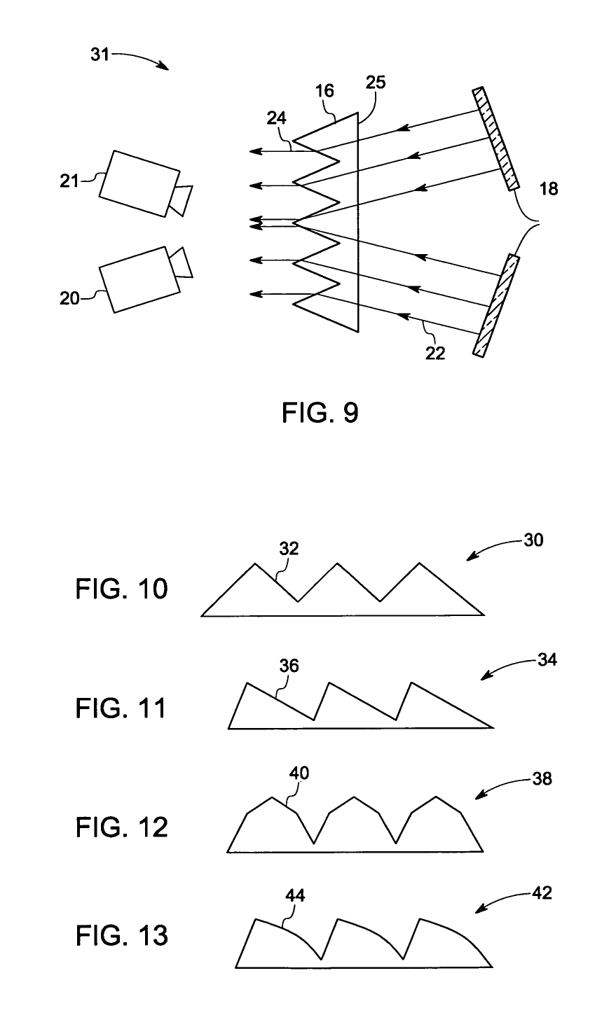

In the illustrated embodiment as shown in FIG. 9, a system 31 is used to image a film with 16 refractive structures such as a light management film with prismatic structures. The system 31 includes at least two illumination sources 18 emitting collimated light, and is placed on one side of the film 16, and at least two imaging devices 20 placed on the other side of the light management film 16. At least one imaging device of the at least two illumination sources 18, and at least one imaging device of the at least imaging devices 20 are in a substantially bright field configuration. The collimated light rays 22 emanating from the illumination sources are incident on the film 16. In this embodiment, the film is disposed in a manner such that the prismatic structures are towards the imaging device as shown in FIG. 9. The collimated light rays 22 from the illumination source 18 are incident at angles off-perpendicular with respect to the plane 25 of the light management film 16. The rays 24 emerge from the film refracted at angles substantially perpendicular to the plane 25 of the film 16 and are not imaged by the imaging devices as the imaging devices are off-perpendicular with respect to the plane of the light management film. The imaging device 20 therefore sees and images a dark field image. In the presence of defects, light may be scattered by the defects and may be imaged by the imaging device.

In some embodiments, a film to be inspected is disposed in a manner such that the refractive structures on the film are on the side facing the illumination source. In some other embodiments, the film is disposed in a manner such that the refractive structures are towards the imaging device. In some embodiments, more than one illumination source may be employed to illuminate the film. In further embodiments, illumination sources may be positioned on either or both sides of the film to be inspected. In some embodiments, the illumination source and the imaging device are configured to image a dark field image of a film. In further embodiments, the illumination source and the imaging device may also be configured to record a bright field image. In some embodiments, the illumination of the prismatic structures may be oblique to the plane 25 of the film. In a non-limiting example, light rays from an illumination source may be incident substantially perpendicular to the prismatic faces. In some embodiments, the imaging device may be positioned at an angle greater than plus or minus 10 degrees from a normal drawn to the plane 25 of the film 16. In some embodiments imaging devices may be present on either or both sides of the film. In a non-liming example, a line scanning imaging device with about 18 micron per pixel resolution and a field of view of about 7.5 cm is used to acquire the image for initial defect detection. On identification of defects, a higher resolution area scanning imaging device with about 3 micron per pixel resolution and a field of view of about 3 mm is used to acquire a high resolution image of the defect to enable classification of defects.

In one embodiment, the image may be inspected by manual visual human inspection. In one embodiment, in a manual visual inspection method, an operator moves the camera to inspect the film and on detection of defects, looks at magnified images of the defects to characterize them. In a non-limiting example, the defects may be characterized by their dimensions and by their average intensity. In another embodiment, image acquisition, image processing and defect detection processes may all be automated.

FIGS. 10, 11, 12, and 13 are schematic cross sectional views of light management films 30, 34, 38, and 42 with different types of refractive surface structures 32, 36, 40, and 44, respectively. Embodiments of the present invention provide systems and methods for inspecting such films.

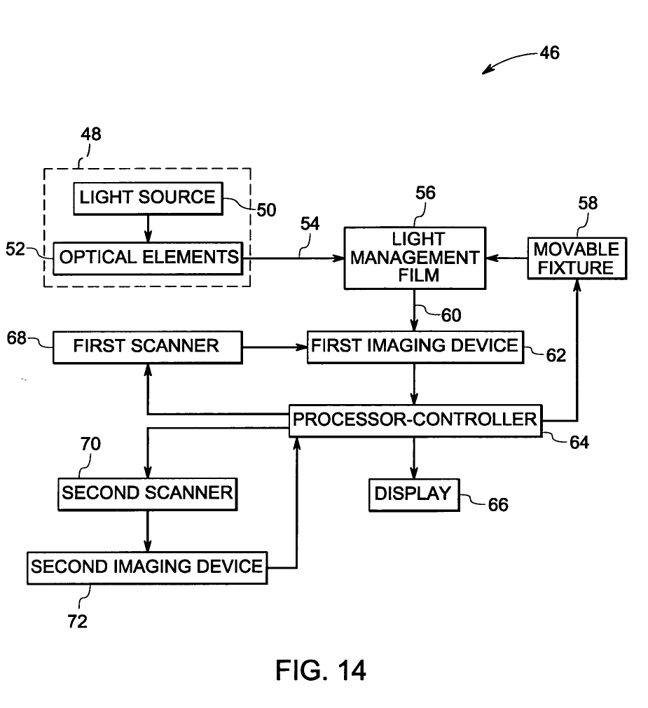

FIG. 14 is a schematic representation of an automated inspection system 46. The system 46 includes an illumination source 48. In some embodiments, the illumination source 48 includes a light source 50 and optical elements 52. In some embodiments, the illumination source 48 is a fiber light source 50 with a focusing element 52 to generate a narrow light line for a line scan imaging device. Non-limiting examples of optical elements include filters and diffusers. A light management film 56 is mounted on a fixture 58, which is operably coupled to a processor-controller 64. A fixture is typically used to provide accurate positioning and rotational orientation for the light management film. In one embodiment, the processor-controller 64 is a computer. The system 46 further comprises a first imaging device 62. In one embodiment the first imaging device 62 and the illumination source 48 are in a substantially bright field configuration. In some embodiments, the first imaging device 66 is also operably mounted to a first scanner 68 and coupled to the processor-controller 54 to spatially scan the first imaging device to enable multiple line scans to image an entire area of interest of the light management film 56. In some embodiments, the illumination source 48 and the first imaging device 62 are operably coupled to reposition in step with each other. In other embodiments, the illumination source 48 and the light management film 56 are operably coupled to reposition in step with each other. In some embodiments, the first imaging device 66 has a resolution of about 20 microns per pixel or less. The light rays 54 from the illumination source 48 is incident on one side of the light management film 56 and the refracted rays 60 emerging from the other side of the light management film 56 are recorded by the first imaging device 62 to provide an acquired image. In one embodiment, the imaging device 62 is a digital camera. In a further embodiment, the imaging device may be operably coupled to the processor-controller enabling reposition for successive line scans. The acquired image is sent to a processor-controller 64 for image processing and automated defect detection. Upon image processing and defect detection, a defect report with a defect map may be displayed on a display 66.

In a further embodiment, a second imaging device 72 may be operably coupled to the processor-controller such that upon selection of a defect on the defect map, the second imaging device 72 repositions to enable imaging of the defect at a higher resolution than the acquired image. In one embodiment, the second imaging device 72 is mounted on a second scanner 70, which is operably coupled to processor-controller 64. A higher resolution image may enable classification of defect types. In one embodiment, the second imaging device has a resolution of about 2 microns per pixel. In a non-limiting example, defects, such as but not limited to prism tip damage, broken prism tips, scratched prism faces, filled-in prism valleys and surface dust particles, which may look similar in a 20 micron per pixel image, in a 2 micron per pixel image may exhibit revealing characteristics, enabling classification of the defect types and enbaling root cause analysis. In one embodiment, root cause analysis identifies the root cause of these defects. This may allow tracking defects back to their source in a manufacturing process for the light management films and allows corrective action that will help mitigate the root causes of such defects.

Defects in prismatic structures in light management films include but are not limited to broken prism tips, scratched prism faces, filled-in prism valleys, inclusions within the prisms, and similar base film defects. The origin of some of the defects, such as scratches, may be attributed to integral defects in electroforms used to make light management films. Superficial defects on the electroform used to make a light management film such as debris may also lead to defects such as stains, spots, spiders and whiskers in the light management film.

The processor-controller 64 may include a computer readable medium, which stores instruction for automated operation of the inspection system and for automated defect detection. In some embodiments, the computer readable medium may be external to the processor-controller such as a computer. The system may further include a display 66 to display an inspection report and a defect map.

In one embodiment of the present invention is a method for automated inspection of light management films. The method includes mounting a light management film with light refractive surface structures on to a fixture, positioning an illumination source on a first side of the film and an imaging device on a second side of the film, the illumination source and the imaging device oriented in a substantially bright field configuration, imaging at least part of the light management film, wherein light from the illumination source is refracted by the film to produce a dark field image at the imaging device. The image is processed and analyzed using a processor-controller. The illumination source, the imaging device, the fixture, and the processor-controller are all operably coupled for automated defect detection.

The processor-controller may employ one or more algorithms to acquire the image, prepare the image, process the image, and detect, characterize, and record defects. In some embodiments, the method uses a monochromatic illumination source. The method may also include the use of light filters to restrict the light cone collected by the imaging device.

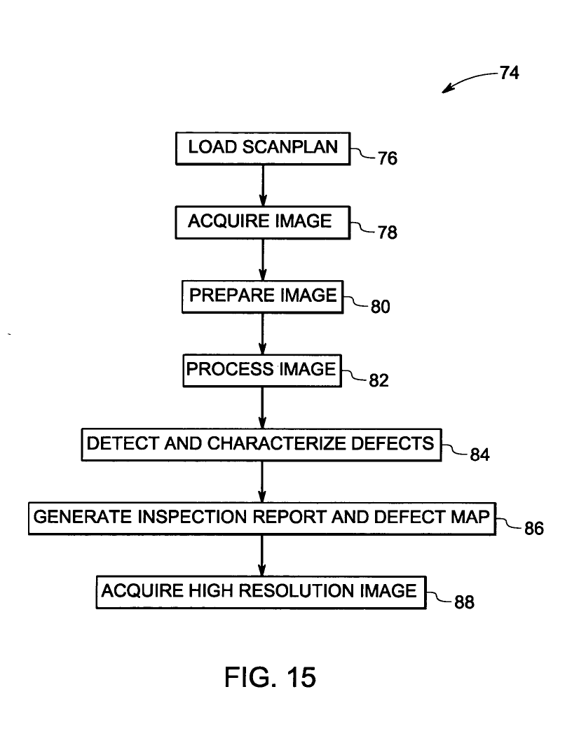

In one embodiment of the present invention is a method for automated inspection of light management films. FIG. 15 is a flow chart illustrating a method 74 for automated inspection of light management films in accordance with certain embodiments of the present invention. As illustrated, the method proceeds by loading a scanplan 76, acquiring an image 78, preparing the image for processing 80, processing the image 82, detecting and characterizing detects 84. In some embodiments, the method proceeds further by generating an inspection report and a defect map 86. In further embodiments, the method 74 proceeds to further image a selected defect feature using a second imaging device of a higher resolution 88 to enable classification of defects and root cause analysis.

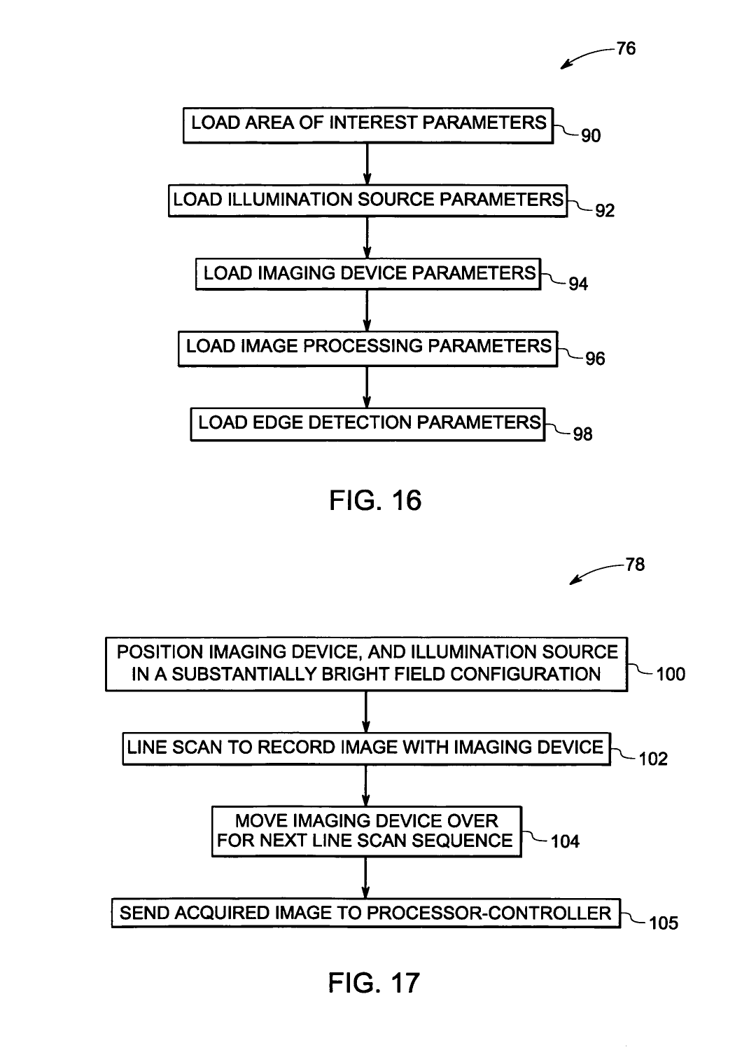

In some embodiments of the present invention, loading a scanplan 76 proceeds by the method illustrated in FIG. 16. Each film being inspected may have individual scanplan. In one embodiment, an operator may select an appropriate scan plan or input the appropriate parameters. The scanplan may include threshold levels, minimum defect sizes, image processing parameters, fiducial detection parameters, product size, imaging device exposure time, translation stage speeds for translation stages coupled to fixtures and scanners. The individual scanplan may depend on the specific application of the inspected film, such as in cell phone displays or LCD TV displays. Parameters defining an imaging area of interest such as dimensions of the part being inspected are loaded 90 on to the processor-controller. Other parameters defining the imaging area of interest include but are not limited to start coordinates for imaging and closest distance to borders of the imaging area of interest beyond which defects would be ignored. Illumination source parameters such as light sources being used for a given imaging set up are loaded in step 92 of method 76. Imaging device parameters such as but not limited to exposure time, and line rate are loaded in step 94. Image processing parameters such as but not limited to threshold ratio, which sets intensity threshold for detection, threshold divide, which identifies the number of sub images the acquired image will be divided into before processing to help factor in non-uniform lighting, maximum size of defects that may be clustered together, minimum size of non-clustered defects to be counted, merging distance how far apart defects can be and still be clustered are loaded in step 96. Edge detection parameters for detecting edges and fiducials are loaded in step 98.

In some embodiments of the present invention, acquiring an image 78 proceeds by the method illustrated in FIG. 17. As illustrated, the method 78 proceeds by positioning the illumination source and imaging device in a substantially bright field configuration 100. The method 78 proceeds by line scanning the light management film to record an image with the imaging device 102. A line scan imaging device is typically used to acquire such an image. In other embodiments an area scan imaging device may also be used. In certain embodiments, the light management film is moved across the imaging device to enable the line scan. The imaging device typically needs to make multiple passes across the light management film to cover the entire light management film area of interest. The method 78 may therefore proceed further by moving the imaging device over to enable the next line scan sequence 98. In one embodiment, imaging occurs at a resolution of about 20 microns per pixel or more. Acquiring an image 78 may further include a scan over alignment fiducials to image the alignment fiducials to enable their removal during image preparation and image processing that may follow the acquisition of the image. The scan for alignment fiducials and edges typically precedes the imaging of the entire film, but in some embodiments, the scanning may take place along with or after the imaging of the entire film. The processor-controller receives the acquired images for defect detection in step 105.

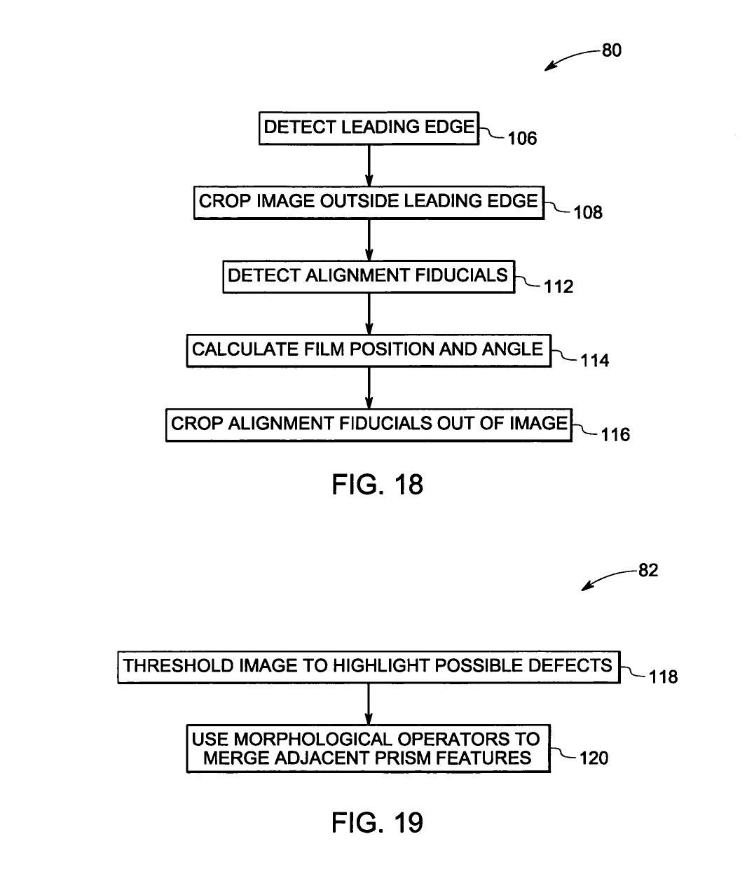

In some embodiments of the present invention, preparing an acquired image for processing 80 proceeds by the method illustrated in FIG. 18. As illustrated, the method proceeds by detecting the leading edge of the film 106. This detection of the leading edge 106 enables the processor-controller to determine start of the inspection area. Determining and eliminating a region in the acquired image falling outside the inspection area helps to avoid detecting false defects outside the area of interest (AOI), which would otherwise require post processing in the acquired image and lead to increase in processing time and reduction in efficiency. Further, detection of the leading edge of the film is important because it allows for the measurement of the defect coordinates with greater accuracy. For example, accuracy of the coordinates is especially desirable when a light management film is die punched to a desired size or shape for a given application. Detecting the leading edge further enables positioning a die in a manner so that defects can be cut from the light management film, increasing production yields. Therefore, following detection of the leading edge, the region in the acquired image falling outside the leading edge is cropped out of the acquired image 108. Preparing the image 80 may also include detecting in the acquired image, fiducials marked on the on the light management film 110. Alignment fiducials are typically marked and detected along the edges of the light management film. Alignment fiducials are marked to enable the measurement of the position and angle at which the light management film is mounted on the fixture. In some embodiments, the fiducials may include seams. The seam is defined as a band of irregular prisms that appear as a bright straight line that runs the length of the display film. The seam closest to the start point of the imaging scan is referred to as a leading seam, while the seam at the opposite edge is referred to as a trailing edge. In a non-limiting example, light management films comprise fiducial marks that include seams located about 25 mm from each edge of the film. Some portions of the alignment fiducials are typically scratched perpendicular to the seam, outside of the usable area. These fiducials are used to define the origin of the coordinate system, from which the defect coordinates are measured.

The method 80 proceeds further by calculating the position and angle at which the light management film is mounted on the fixture 114 using coordinates of the alignment fiducials. The method 80 proceeds by cropping the alignment fiducials out of the acquired image 116 to provide a prepared image. The removal of fiducials avoids the possibility of false defect detections along the alignment fiducials, and the prepared image is now ready for image processing. As in the case with the detection of leading edge, the detection of alignment fiducials also enables the detection of defects with greater accuracy. For example, light management films in liquid crystal displays are typically die punched to a specific size and shape. Knowing the position of the defects with accuracy is quite desirable so that a die can be positioned to punch out the least defective portion of the light management film.

In embodiments of the present invention, processing the prepared image 82 proceeds as illustrated in FIG. 19. As illustrated, processing of the prepared image 82 proceeds by image thresholding to highlight possible defects 118. In a non-limiting example, thresholding is accomplished by setting pixels in the prepared image that are above a pre-determined intensity level to 1 and all other pixels to 0. This has the effect of highlighting possible defects while removing the background non-defective portion of the image. Thresholding at least in part facilitates the suppression of background features while highlighting defects, which is especially important for the inspection of light management film with prismatic features. The method 82 proceeds to use morphological operators to merge adjacent prism features using an image processing algorithm 120. Prism damage defects typically appear as multiple bright spots in proximity to each other. It may be advantageous to merge certain defect features arising from a single defect. In one embodiment, the image processing algorithm uses morphological operators to transform an image to provide a processed image. Non-limiting examples of morphological operators used by the image processing algorithm are dilate, close and erode. An image transformed using morphological operators generally has fewer details, but the main features are highlighted. The image processing algorithm merges adjacent prism tips together so that the defect is counted only once during defect detection. This avoids defects from being counted multiple times, and is a desirable feature to accurately count defects. Depending on the resolution of the imaging device, defects such as prism tip defects appear as single defects or multiple defects in the image. In some embodiments imaging devices at different resolutions may be used to acquire a plurality of images of the light management film. In a non-limiting example, a higher resolution image may be used to classify defects, whereas a lower resolution image may be used to merge adjacent defect features. The processed image is ready for defect detection and characterization.

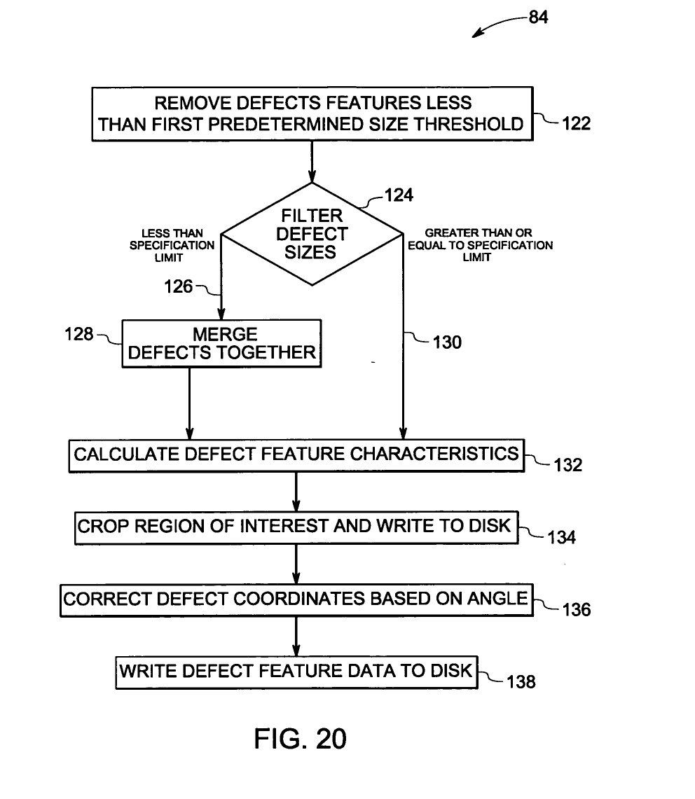

In some embodiments of the present invention, defect detection 84 proceeds by the method illustrated in FIG. 20. As illustrated, the method proceeds by removing defect features from the processed image below a first predetermined size threshold 122. As used herein, the term “size” refers to the average of the length and the width of the defect feature. In one embodiment, the first predetermined size threshold may be determined by the size limits of detection upon human visual inspection. In a non-limiting example, the first predetermined size threshold may be 0.05 mm. The human eye is generally unable to detect defects that have sizes below 0.05 mm. In one embodiment, the defect detection method 84 proceeds by filtering defects into a class of defect features having size below a second predetermined size threshold and a class of defect features 124 having size about or above the second predetermined size threshold. This enables different classes of detect features to be processed using different algorithms. In one embodiment, the second predetermined size threshold may be determined by a specification requirement for a particular application of the light management film. In a non-limiting example, a second predetermined size threshold may be about 0.15 mm. For the class of defect features below the second predetermined size threshold 126, the method 84 proceeds to merge a cluster of small defect features that are localized in a small area 128. Defect features below a certain size may not be independently visible upon visual inspection, but a collection of these defects is noticeable on visual inspection and hence desirably needs to be counted as defects. The algorithm measures the distance between the defect features below the second predetermined size threshold, and if below a predetermined limit, are clustered together and counted as a single defect feature. For defects at or above the second predetermined size threshold 130, the method 84 proceeds to characterize the defects.

The method 84 proceeds by measuring and calculating defect feature characteristics 132 for the different classes of defect features. Defect feature characteristics include physical and optical characteristics. Non-limiting examples of defect characteristics include size, dimensions, aspect ratios, and orientation. In a one embodiment, for the class of defect features above the second predetermined size threshold, the defect features may be categorized depending on their size as large, medium and small. In a non-limiting example, a large defect feature has a size greater than 1 mm, a medium defect feature has a size from 0.5 mm to 1 mm, and a small defect feature has a size from about 0.15-0.5 mm. In a still further embodiment, each size category of defect features is further categorized by intensity of the defect feature. In one embodiment, the defect features are categorized as high severity, medium severity, and low severity. In a non-limiting example, a high severity defect has an intensity level greater than 180 gray scale values on an 8 bit scale, a medium severity defect feature has an intensity level from about 150 to about 180 gray scale values on an 8 bit scale, and a low severity defect feature has an intensity level greater than about 120 to about 150 gray scale values. In one embodiment, the defect detected has at least one dimension 100 microns or greater. The method 84 proceeds to crop a region of interest (ROI) 134 including the defect feature and writing it to a disk or computer readable medium. The defect feature image is cropped using defect coordinates, which include the length and width of the defect feature. The method 84 may proceed further to correct defect co-ordinates 136 by transforming the defect feature image coordinates such that the axes are parallel and perpendicular to the edges of the light management film. This coordination transformation is facilitated by using the angle the light management film subtends with the fixture, which is calculated using the alignment fiducials as discussed above. This transformation enables reduction in errors in defect positions, and helps maximum utilization of the light management film. By transforming the images of successive films to identical coordinate axes, defects located at substantially identical positions or locations on the display film can be identified and source of the defect may be identified and eliminated. The method 84 may also proceed to write to a disk the defect feature characteristics using the corrected co-ordinates 138. As discussed in FIG. 15, the automated inspection method 74 may proceed to print or display an inspection report including a defect map. Desirably, an ROI is saved to disk for each defect. This image of the defect along with its coordinates can help in identifying the origin of the defect, such as a defect in electroform used to form the light management film.

The method 74 may further include the selection of defects on the defect map, which will automatically position a high resolution area scanning imaging device at such a point to enable high resolution imaging of the selected defect 88 to enable classification of defects and root cause analysis. The selection of the defect may be achieved by a mouse click over the defect in the defect map.

As will be appreciated by those skilled in the art, the embodiments and applications illustrated and described above will typically include or be performed by appropriate executable code in a programmed computer. Such programming will comprise a listing of executable instructions for implementing logical functions. The listing can be embodied in any computer-readable medium for use by or in connection with a computer-based system that can retrieve, process and execute the instructions.

In the context of embodiments of the present invention, the computer-readable medium is any means that can contain, store, communicate, propagate, transmit or transport the instructions. The computer readable medium can be an electronic, a magnetic, an optical, an electromagnetic, or an infrared system, apparatus, or device. An illustrative, but non-exhaustive list of computer-readable mediums can include an electrical connection (electronic) having one or more wires, a portable computer diskette (magnetic), a random access memory (RAM) (magnetic), a read-only memory (ROM) (magnetic), an erasable programmable read-only memory (EPROM or Flash memory) (magnetic), an optical fiber (optical), and a portable compact disc read-only memory (CDROM) (optical). Note that the computer readable medium may comprise paper or another suitable medium upon which the instructions are printed. For instance, the instructions can be electronically captured via optical scanning of the paper or other medium, then compiled, interpreted or otherwise processed in a suitable manner if necessary, and then stored in a computer memory.

In one embodiment of the present invention, the computer-readable medium may store instructions for instructing a processor-controller for generating a scanplan for inspection and defect detection of a light management film. The instructions may include instructions to load a geometric model of the light management film and the fixture and generate a scanplan of the light management film based on the geometric model and at least one scanning parameter. In a non-limiting example, the scanning parameter is the length of the light management film. The computer-readable medium may further include instructions for line scanning at least part of the light management film. The instructions may include traversing the light management film across the imaging device and recording the image, to provide an acquired image. The computer-readable medium may further include instructions for repositioning of the imaging device relative to the light management film for performing a plurality of scans through a length of the light management film to cover an area of interest of the light management film.

The computer-readable medium may further include instructions for performing at least one of detecting a leading edge of the light management film in the acquired image and cropping the area outside of interest of the acquired image. The computer-readable medium may further include instructions for detecting the alignment fiducials. The computer-readable medium may include instructions for performing at least one of calculating an angle subtended by the light management film with the fixture using coordinates of alignment fiducials, removing the alignment fiducials by cropping the alignment fiducials to provide a prepared image. The computer-readable medium may further include resetting each existing pixel intensity level in the prepared image using a predetermined intensity level threshold to highlight defect features and to remove non-defective portion of the prepared image. Instructions for using morphological operators to merge adjacent prisms features to provide a processed image, removing features below a first predetermined size threshold to leave behind measurable defect features in the processed image, and filtering the defect features in the processed image by size and merging adjacently placed defect features below a second predetermined size threshold to form unitary defect features may also be included in the computer-readable medium.

The computer-readable medium may further include instructions for calculating defect feature characteristics and to crop and store a defect image in a computer-readable medium. Instructions for transforming coordinates of a defect image to coordinates of edges of the light management film may also be found in the computer readable medium. The computer readable medium may further include instructions for generating a defect feature map showing defect locations and displaying the defect map on a display. The computer readable medium may also further include instructions to enable selection of defects on the defect map display on the display, which will enable automatic positioning of a higher resolution area scanning imaging at a point to enable imaging of the selected defect to enable classification of defects and root cause analysis. The selection of the defect may be achieved by a mouse click over the defect in the defect map.

Without further elaboration, it is believed that one skilled in the art can, using the description herein, utilize the present invention to its fullest extent. The following examples are included to provide additional guidance to those skilled in the art in practicing the claimed invention. The examples provided are merely representative of the work that contributes to the teaching of the present application. Accordingly, these examples are not intended to limit the invention, as defined in the appended claims, in any manner.

The below examples demonstrate the use of a system for inspection to detect defects in light management films. After acquiring an image, detecting and cropping the alignment fiducials and areas outside of interest in the acquired image, features below specification limit were removed, and the image was processed.

### EXAMPLE 1

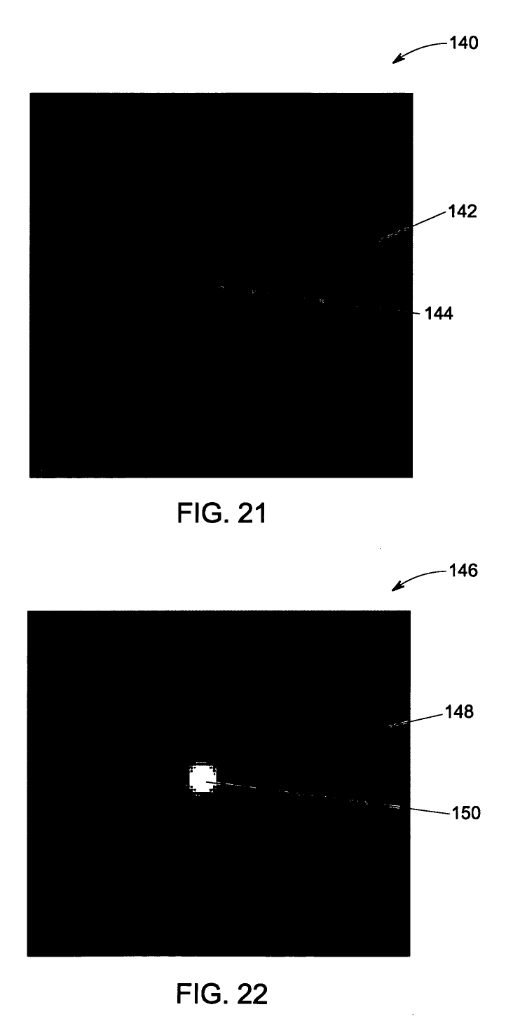

FIG. 21 shows a micrograph image of a light management film 140 with prismatic structures disposed on the side facing the imaging device in a configuration as shown in FIG. 4. It is seen that a defect feature is visible as a dark spot 144 on a dark background 142.

### EXAMPLE 2

FIG. 22 shows a micrograph image of a light management film 146 with prismatic structures disposed on the side facing the illumination source in a configuration as shown in FIG. 2. It can be seen that a defect feature is visible as a bright spot 150 on a dark background 148.

### EXAMPLE 3

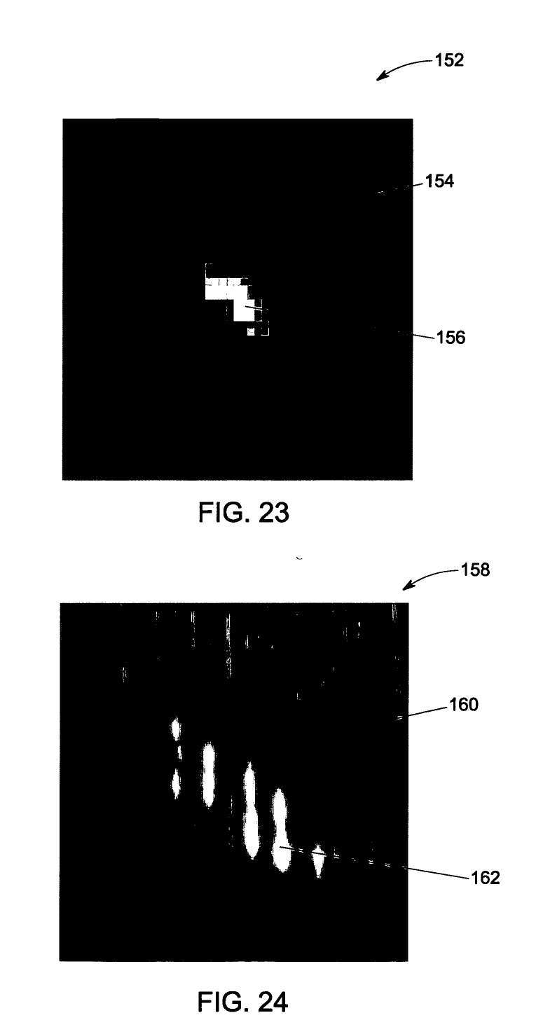

FIG. 23 shows a processed image 152 of an image acquired using a 20 micron per pixel resolution imaging device. It is seen that a defect feature is visible as a bright spot 156 on a dark background 154. The defect feature coordinates were determined and a second imaging device capable of imaging at 2 micron per pixel resolution was moved to the site of the defect to image the defect at a higher resolution. FIG. 24 shows a processed image 158 of an image acquired using a 2 micron per pixel resolution imaging device. It can be see that defect feature 162 (same as defect feature 156 seen in FIG. 23) has been resolved into multiple spots in the higher resolution image and is seen against a dark background 160. The defect characteristics indicate a prism tip damage type defect.

### EXAMPLE 4

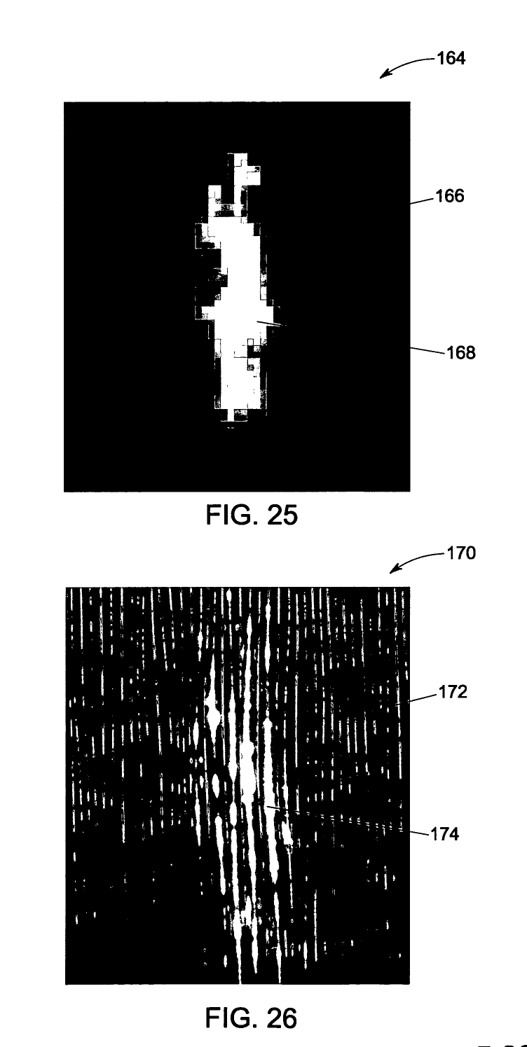

FIG. 25 shows a processed image 164 of an image acquired using a 20 micron per pixel resolution imaging device. It is seen that a defect feature is visible as a bright spot 168 on a dark background 166. The defect feature coordinates were determined and a second imaging device capable of imaging at 2 micron per pixel resolution was moved to the site of the defect to image the defect at a higher resolution. FIG. 26 shows a processed image 170 of an image acquired using a 2 micron per pixel resolution imaging device. It can be seen that defect feature 174 (same as defect feature 168 seen in FIG. 25) has been resolved into multiple spots in the higher resolution image and is seen against a dark background 172. The defect characteristics indicate a prism tip damage type defect.

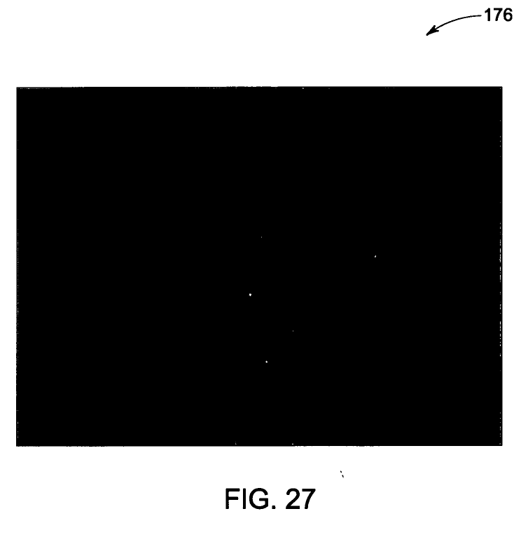

FIG. 27 shows a micrograph image of a light management film 176 with prismatic structures disposed on the side facing the imaging device in a configuration as shown in FIG. 7. The imaging device angle θ₂ is about 20 degrees.

The embodiments of the present invention provide dark field imaging, to produce bright field images. Further embodiments of the present invention for automated defect detection enable improvement in process improvement and quality control. Current methods of inspection are human inspection methods with limited reliability. An automated inspection system is very repeatable and can be designed to be very sensitive to specific defect types. It is expected that the automated inspection system of the present invention will reduce the inspection time from about 2 to 3 hours for human inspection, to about 10 to about 15 minutes for automated inspection using embodiments of systems and methods of the present invention. In addition, an automated inspection system will have a high degree of repeatability and reliability.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for inspection of light management films, the method comprising:
providing a light management film comprising a plurality of light refractive surface structures;
mounting said light management film onto a fixture;
positioning at least one illumination source to illuminate a first side of the light management film, and positioning at least one imaging device on a side opposite said first side, wherein the at least one illumination source, and the at least one imaging device are configured to be in a substantially bright field configuration; and
imaging at least portion of the light management film to provide an acquired image, wherein light from the at least one illumination source is refracted by the film to produce a dark field image at the at least one imaging device.

2. The method of claim 1, further comprising processing the acquired image using a processor-controller, wherein the illumination source, the imaging device, and the processor-controller are operably coupled for automated defect detection.

3. The method of claim 2, further comprising loading a scanplan to enable automated inspection of light management film.

4. The method of claim 3, wherein mounting a light management film on to a fixture comprises mounting the light management film on to a movable fixture to enable scanning the light management film across the at least one imaging device.

5. The method of claim 3, wherein mounting a light management film on to a fixture further comprises aligning the light management film within the fixture.

6. The method of claim 3, wherein positioning at least one imaging device comprises positioning using a repositionable mount.

7. The method of claim 3, wherein the at least one illumination source and the at least one imaging device are operably coupled to reposition in step with each other.

8. The method of claim 3, wherein the at least one illumination source and the light management film are operably coupled to reposition in step with each other.

9. The method of claim 3, wherein imaging at least portion of the light management film comprises line scanning at least part of the light management film.

10. The method of claim 9, wherein line scanning comprises scanning the light management film across the at least one imaging device and acquiring an image.

11. The method of claim 10, wherein line scanning comprises making a plurality of line scans of the light management film to cover an entire area of interest of the light management film.

12. The method of claim 9, wherein imaging comprises recording an image at a resolution of about 20 micron per pixel.

13. The method of claim 3, further comprising area scanning at least part of the light management film.

14. The method of claim 3, further comprising using one or more optical elements to direct light from the illumination source in a predetermined configuration.

15. The method of claim 3, further comprising scanning to image alignment fiducials in the light management film.

16. The method of claim 15, further comprising:
detecting the leading edge in the acquired image;
cropping the region outside of interest of the acquired image;
detecting alignment fiducials in the acquired image;
calculating position of light management film using co-ordinates of alignment fiducials;
calculating an angle subtended by the light management film with the fixture using co-ordinates of alignment fiducials; and
removing the alignment fiducials by cropping the alignment fiducials from the acquired image to provide a prepared image.

17. The method of claim 16, wherein processing the image comprises:
resetting each existing pixel intensity level based on a predetermined threshold intensity level in the prepared image to highlight possible defect features.

18. The method of claim 17, wherein processing the image further comprises using morphological operators to merge adjacent prisms features to provide a processed image.

19. The method of claim 18, further comprising
removing defect features below a first predetermined size threshold; and
filtering the defect features in the processed image by size and merging adjacently placed defect features below a second predetermined size threshold.

20. The method of claim 19, wherein the second predetermined size threshold is about 150 microns.

21. The method of claim 19, further comprising calculating defect feature characteristics.

22. The method of claim 21, wherein the defect feature characteristic comprises at least one characteristic selected from the group consisting of size, dimensions, aspect ratio, orientation and combinations thereof.

23. The method of claim 21, further comprising cropping a region including at least one defect feature to provide a defect image and saving it to a computer readable medium.

24. The method of claim 23, further comprising transforming coo-ordinates of the defect image to coordinates of edges of the light management film using the calculated position and angle of the light management film to provide a coordinate transformed defect image.

25. The method of claim 24, further comprising saving the co-ordinate transformed defect image to a computer readable medium.

26. The method of claim 25, further comprising generating a defect feature map showing defect locations.

27. A method for automated inspection of a film comprising a plurality of light refractive surface structures, the method comprising:
providing a film comprising a plurality light refractive surface structures on a first side of said film;
mounting said film onto a fixture;
positioning at least one illumination source to illuminate the film, and positioning at least one imaging device to receive light emerging from the film, wherein the at least one illumination source, and the at least one imaging device are configured to be in a substantially bright field configuration;
imaging at least portion of the film to provide an acquired image, wherein light from the at least one illumination source is refracted by the film to produce a dark field image at the at least one imaging device; and
processing the acquired image using a processor-controller, wherein the illumination source, the imaging device, the film, and the processor-controller are operably coupled for automated defect detection.

28. The method of claim 27, wherein the first side of said film is disposed facing the at least one illumination source.

29. A computer-readable medium comprising instructions for generating a scanplan for inspection of a light management film, the instructions comprising:
an instruction to load a geometric model of the light management film and the fixture; and
an instruction to generate a scanplan of the light management film based on the geometric model and at least one scanning parameter.

30. The computer-readable medium of claim 29, further comprising:
instructions for line scanning at least part of the light management film, wherein line scanning comprises scanning the light management film across at least one imaging device and recording the image, to provide an acquired image; and
instructions for repositioning of the at least one imaging device relative to the light management film for performing a plurality of scans through a length of the light management film to cover a region of interest of the light management film.

31. The computer-readable medium of claim 30, further comprising:
instructions for detecting leading edge in the acquired image;
instructions for cropping region outside of interest of the acquired image;
instructions for calculating position of light management film using co-ordinates of alignment fiducials;
instructions for angle subtended by the light management film with the fixture using co-ordinates of alignment fiducials; and
instructions for removing the alignment fiducials by cropping the alignment fiducials and to provide a prepared image.

32. The computer-readable medium of claim 31, further comprising:
resetting each existing pixel intensity level in the prepared image using a predetermined intensity level threshold to highlight defect features and remove non-defective portion of the prepared image; and
using morphological operators to merge adjacent prisms features to provide a processed image.

33. The computer-readable medium of claim 32, further comprising:
instructions for removing features below a first predetermined size threshold;
instructions for filtering the defect features the processed image by size and merging adjacently placed defect features below a second predetermined size threshold;
instructions for calculating defect feature characteristics;
instructions for instructions for cropping a region including at least one defect feature to provide a defect image and saving it to a computer readable medium; and
instructions for instructions for transforming coordinates of the at least one defect image to coordinates of edges of the light management film using the calculated position and angle of the light management film.

34. The computer-readable medium of claim 33, further comprising instructions for generating a defect feature map showing defect locations.

35. The computer-readable medium of claim 34, further comprising instructions for imaging a selected defect feature on the defect feature map at a higher resolution.

36. An automated inspection system comprising:
a fixture for mounting a film comprising a plurality of light refractive surface structures;
at least one illumination source to illuminate a first side of the film;
at least one imaging device to receive light refracted through an opposite side of the light management film, wherein the illumination source and the imaging device are configured to be in a substantially bright field configuration to acquire a dark field image;
a processor-controller; and
a computer-readable medium;
wherein the fixture, the illumination source, the imaging device, the processor-controller and the computer readable medium are operably coupled for automated defect detection, wherein the computer readable medium comprises:
instructions for loading a scanplan;
instructions for automated acquisition of an image to provide an acquired image;
instructions for automated preparation of the acquired image for processing to provide a prepared image;
instructions for automated processing of the prepared image to provide a processed image;
instructions for automated defect detection; and
instructions for generation of inspection report.

37. The inspection system of claim 36, wherein the at least one illumination source is a diffuse source.

38. The inspection system of claim 36, wherein the at least one illumination source is a monochromatic source.

39. The inspection system of claim 36, wherein the at least one illumination source further comprises one or more optical elements to direct light in a predetermined configuration.

40. The inspection system of claim 39, wherein the one or more optical elements comprises a filter to restrict the light cone collected by the at least one imaging device.

41. The inspection system of claim 36, wherein the at least one imaging device is a digital camera.
